(19) United States
(12) Patent Application Publication
(10) Pub. No.: US 2020/0173158 A1
(43) Pub. Date: Jun. 4, 2020

(54) Apparatus and Method for Providing Access to Buried Pipeline

(71) Applicant: LMK Technologies, LLC, Ottawa, IL (US)

(72) Inventors: Larry W. Kiest, JR., Ottawa, IL (US); Bruce Kamin, Ottawa, IL (US)

(73) Assignee: LMK Technologies, LLC, Ottawa, IL (US)

(21) Appl. No.: 16/208,140

(22) Filed: Dec. 3, 2018

(51) Int. Cl. E03F 3/04; F16L 41/12; F16L 41/08; F16L 41/06

(52) U.S. Cl. CPC E03F 3/04; F16L 41/06; F16L 41/082; F16L 41/12

(57) ABSTRACT

A method and apparatus for providing access to a buried pipe by excavating the ground to expose the pipe then attaching an access assembly to the pipe. The access assembly includes a curved plate with an aperture therein substantially aligned with an opening in the pipe. The access assembly has multiple sweeps, each sweep combined with a riser pipe. A first sweep is combined with the curved plate and substantially aligned with the aperture in the curved plate. A second sweep is in communication with the first sweep through an opening, the second sweep has an internal wall with an upper wall portion. The wall in the second sweep is angled downward and inward from the upper wall portion toward the opening so that components inserted into its riser pipe travel downward through the riser pipe then inward toward the aperture as the component passes through the second sweep. The access assembly may include a third sweep similar to the second sweep but on the opposite side of the first sweep and having an angled portion in the opposite direction.

### BACKGROUND OF THE INVENTION

The present invention relates to an apparatus and method for providing access to a buried pipeline. More specifically, the present invention relates to an apparatus and method for providing directional access to a buried pipeline which allows liners, cameras, and other pipeline rehabilitation components to be inserted into the pipe in an upstream or downstream direction.

Conventional sewer lines include a main pipeline which extends along the street in a direction parallel to the street. Each home has a lateral pipeline that extends from the home and connects to the main pipeline. It is often desirable to provide a clean out to the lateral pipeline adjacent the main sewer line. Many lateral pipelines have been buried without such a clean out. In order to provide such a clean out it is necessary to make a wide and extensive excavation so that persons can enter the excavation and attach the clean out pipe to the lateral pipe. This results in considerable disruption of the soil and the yard around the home.

Existing devices have been created to allow access to a buried pipeline without requiring a full and extensive excavation. Some of these existing devices are described in U.S. Pat. No, 6,705,801 issued Mar. 16, 2004 and U.S. Pat. No. 9,151,410 issued Oct. 6, 2015, both of which are hereby expressly incorporated by this reference. Generally, these existing devices include an access assembly having a curved plate with an aperture therein. The curved plate is attached to the lateral pipe beneath the ground surface. An access pipe extends down from the ground surface and is combined with the curved plate so that the aperture in the curved plate is in communication with the access pipe. An access hole is cut in the upper side of the lateral sewer pipe to provide communication from the access pipe (at ground level) to the interior bore of the lateral sewer pipe. One problem with this device is that the access pipe intersects the lateral pipe generally perpendicularly, which can make it difficult to insert a liner or other pipe rehabilitation component into the lateral pipe in an upstream or downstream direction.

Therefore, one object of the invention is the provision of an apparatus and method for providing access to buried pipeline which allow easier insertion of pipe rehabilitation components into the lateral pipe in either the upstream or downstream direction.

A further object of the invention is the provision of an apparatus and method for providing access to buried pipeline using an access assembly having multiple sweeps angled toward the access opening in the top of the lateral pipe which allow easier insertion of pipe rehabilitation components into the lateral pipe in either the upstream or downstream direction.

A further object of the invention is the provision of an improved apparatus and method for providing access to buried pipeline.

A further object of the invention is the provision of an apparatus and method for providing access to buried pipelines which creates a minimum of disruption of the soil.

A further object of the invention is the provision of an apparatus and method for providing access to buried pipeline which does not require a person to enter the excavation to place the riser pipe or clean out pipe to the buried pipeline.

A further object of the invention is the provision of a device which is efficient in operation, economical in cost, and simple in construction.

### SUMMARY

One aspect of the invention relates to an apparatus for providing access to an interior bore of a pipe located below a surface of the ground and having an outer surface. The apparatus includes a curved plate adapted to engage the outer surface of the pipe. The curved plate has an aperture therein. A first sweep is combined with the curved plate and substantially aligned with the aperture in the curved plate. A second sweep is in communication with the first sweep through an opening, the second sweep has an internal wall with an upper wall portion. The wall in the second sweep is angled downward from the upper wall portion toward the opening. Some embodiments further include a third sweep which creates a bi-directional fitting apparatus. The third sweep is similar to the second sweep but positioned on the opposite side of the first sweep. The third sweep is in communication with the first sweep through an opening, the third sweep has an internal wall with an upper wall portion. The wall in the third sweep is angled downward from the upper wall portion toward the opening.

Another aspect of the invention relates to an apparatus for providing access to an interior bore of a pipe located below a surface of the ground and having an outer surface. The apparatus includes a curved plate adapted to engage the outer surface of the pipe, the curved plate having an aperture therein. A first sweep is combined with the curved plate and substantially aligned with the aperture in the curved plate. A second sweep has an internal wall with an upper wall portion extending in a first direction, a lower wall portion extending in a second direction, and an angled wall portion between the upper wall portion and the lower wall portion. There is an opening between the first sweep and the second sweep to allow a liner or other pipe rehabilitation component to pass from the second sweep to the first sweep then into the pipe through the aperture. The angled portion of the internal wall of the second sweep extends at a downward angle toward the aperture in the curved plate. Some embodiments of the apparatus further include a third sweep which creates a bi-directional fitting apparatus. The three sweeps are arranged so the first sweep is in the middle and the other two sweeps are on opposing sides of the first sweep. Similar to the second sweep but on the opposite side of the first sweep, the third sweep has a wall with an upper wall portion extending in a first direction, a lower wall portion extending in a second direction, and an angled wall portion between the upper wall portion and the lower wall portion. There is an opening between the first sweep and the third sweep to allow a liner or other pipe rehabilitation component to pass from the third sweep into the first sweep then into the pipe through the aperture.

Another aspect of the invention relates to an access assembly having a saddle adapted to surround a portion of the outer peripheral surface of a lateral pipe. The saddle has an aperture adapted to allow access into the lateral pipe through an access opening cut in the upper surface of the lateral pipe. The saddle of the access assembly comprises a curved plate conforming to the outer peripheral surface of the lateral sewer pipe. The outer peripheral surface of the lateral pipe extends in a circle 360°. The curved plate comprises a flexible material that permits the curved plate to flex in an outward radial direction and then snap back to its original curved configuration during the connection of the curved plate to the outer peripheral surface of the lateral sewer pipe. The saddle includes two or more upwardly extending sweeps. Each sweep is directly or indirectly combined with the saddle and has a lumen or bore therein adapted to allow a liner or other pipe rehabilitation component to pass through. In one embodiment, the saddle includes three upwardly extending sweeps—a central (first) sweep substantially aligned with the aperture in the saddle, an upstream (second) sweep having an opening providing communication between the central sweep and the upstream sweep, and a downstream (third) sweep having an opening providing communication between the central sweep and the downstream sweep. The upstream and downstream sweeps have an angled inner wall portion extending downward toward the aperture. The angled portions change the direction of the liner or other component after it travels down through the riser pipe in a first direction then is turned in a second direction (inward) toward the central sweep. The angled portion extends inwardly and downwardly toward the aperture in the saddle. Each sweep is adapted to be combined with a riser pipe which extends upwardly therefrom. Each riser pipe includes a lower end combined with its respective sweep and an upper end adjacent the surface of the ground. Each riser pipe also has an internal lumen or bore providing communication from the upper end thereof to its respective sweep combined with the lower end thereof. This results in the internal bore of each riser pipe providing access from the upper end thereof to the interior bore of the lateral sewer pipe. This access assembly can be used for clean out purposes, but it can also be used for making internal repairs to the lateral sewer pipe. It is possible to invert liner tubes or insert other pipe rehabilitation components into the lateral sewer pipe through one of the riser pipes. Lining or inserting other components through the upstream riser pipe causes the component to be lowered into the riser pipe in a first direction then change directions as it passes through the second or third sweeps. The change in direction allows the component to begin moving in the desired direction (upstream or downstream) before the component even enters the pipe. More specifically, inserting a component through the upstream sweep causes the component to begin moving in the downstream direction before it enters the pipe through the access opening. Conversely, inserting a component through the downstream sweep causes the component to begin moving in the upstream direction before it enters the pipe through the access opening.

Another aspect of the invention includes a method of inserting a liner, camera, or other pipe rehabilitation component into a lateral pipe through a riser pipe. The ground is first excavated to expose a portion of the lateral sewer pipe. This excavation can be minimal because all that is necessary is to provide a two foot diameter access hole in the ground rather than an excavation that is sufficiently large to permit a person to enter the access hole. Next the installer takes an access assembly having a curved plate forming a concave surface and at least two sweeps extending upwardly from the curved plate. In one embodiment, the access assembly includes three sweeps—a central (first) sweep extending upward from the opening in the saddle, an upstream (second) sweep having an opening providing communication into the central sweep, and a downstream (third) sweep having an opening providing communication into the central sweep. The upstream and downstream sweeps have inner wall portions which angle downward and inward toward the central sweep to change the direction of a pipe rehabilitation component after it has been lowered into the riser pipe. The concave surface of the curved plate is then attached in facing relation over the outer curved surface of the exposed portion of the buried pipe. The attaching step includes forcing the concave surface of the curved plate into contact with the outer curved surface of the buried pipe whereby the concave surface will first flex in an outward radial direction and then will flex in an inward radial direction to retentively embrace the outer curved surface of the buried pipe. This step may be done remotely by the installer from above ground merely by pressing down on the upstanding riser pipe to snap the curved plate in retentive engagement over the buried pipe. The concave surface of the curved plate is adhered and sealed to the outer curved surface of the exposed portion of the buried pipe by applying an adhesive to the concave surface of the curved plate before attaching the curved plate to the pipe. After attachment of the two components, the adhesive is allowed to cure. An access opening in cut in the buried pipe wall of the buried pipe, the access opening providing communication between the central sweep and the interior bore of the buried pipe so as to provide access to the interior bore of the buried pipe. After the access assembly is attached, a user may insert a pipe rehabilitation component through the riser pipe combined with either of the second or third sweeps. The component travels generally vertically down the riser pipe then the angled portion of the sweep causes the component to change directions by angling the component downward and inward toward the aperture opening in the central sweep. The change in direction allows the component to begin moving in the desired direction before the component even enters the pipe. More specifically, inserting a component through the upstream sweep causes the component to begin moving in the downstream direction before it enters the pipe through the access opening. Conversely, inserting a component through the downstream sweep causes the component to begin moving in the upstream direction before it enters the pipe through the access opening.

### BRIEF DESCRIPTION OF THE DRAWINGS

FIG. 1 is a side view of the access assembly showing the central opening in the saddle and the openings between the central sweep and the upstream and downstream sweeps.

FIG. 2 is a side view similar to FIG. 1 but showing an embodiment where the angled portion of the outer sweeps is straight instead of curved.

FIG. 3 is a side view of the access assembly combined with a lateral pipe.

FIG. 4 is a perspective partially exploded view of the access assembly combined with a lateral pipe.

FIG. 5 is a sectional view showing a buried lateral and main sewer pipe and the access assembly for providing access to the interior of the lateral sewer pipe.

FIG. 6 is a sectional view taken along line 1-1 in FIG. 3.

### DETAILED DESCRIPTION

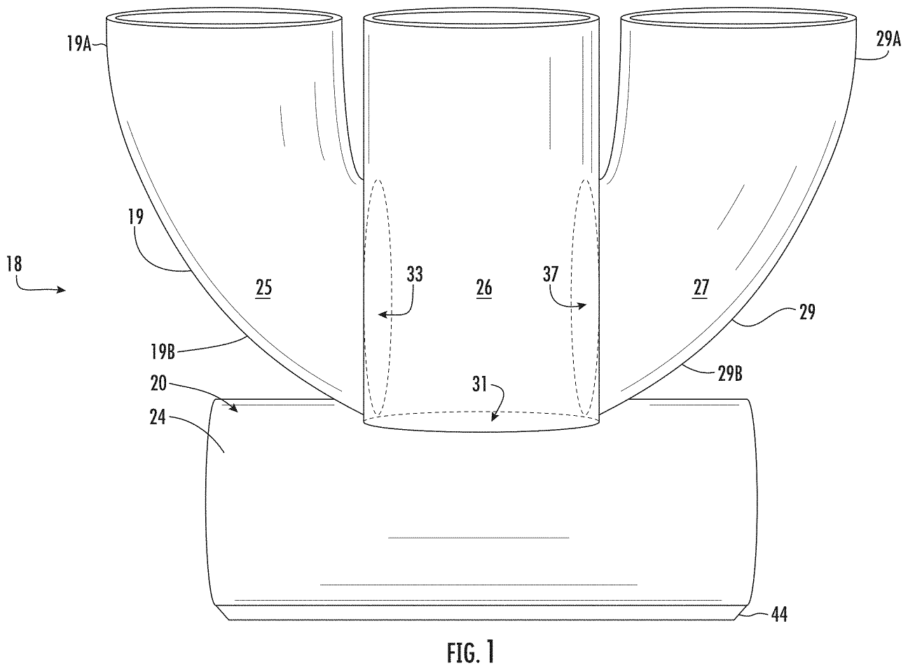

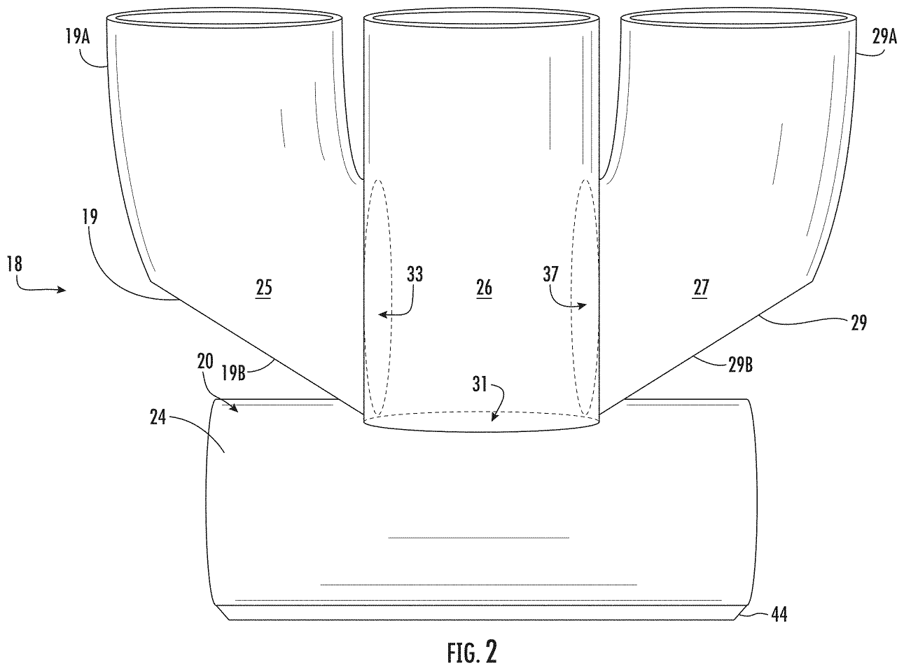

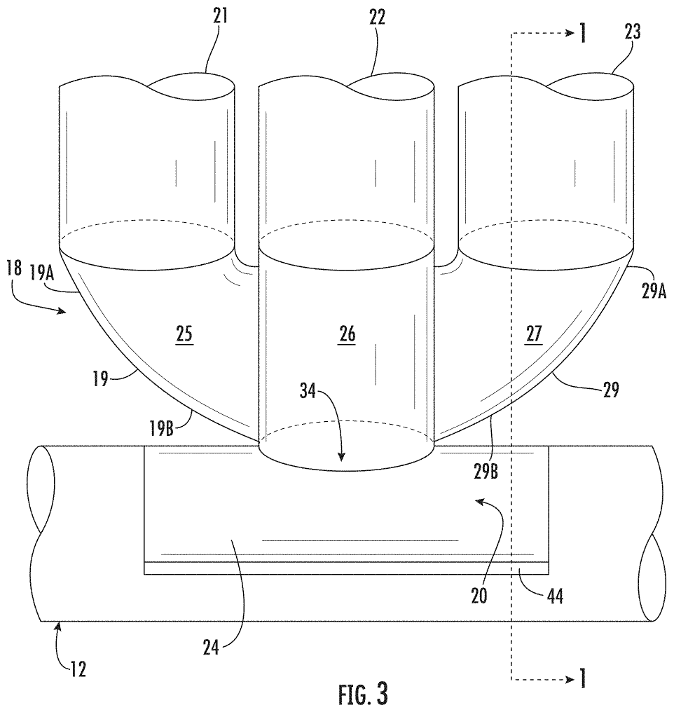

Referring to the drawings the numeral 10 designates a main sewer line and the numeral 12 designates a lateral sewer line, both of which are buried in the ground 14 which has an upper surface 16. An access assembly 18 provides access to the interior of the buried lateral sewer pipe 12. As shown in FIGS. 1-3, the access assembly 18 includes a saddle 20 and at least two sweeps 25, 26, 27. The embodiment shown in the figures includes three sweeps 25, 26, 27. Each sweep 25, 26, 27 is adapted to be combined with a corresponding riser 21, 22, 23 and includes a bore or wall therein. Saddle 20 includes a curved plate 24 which may include a pair of outwardly flared flanges 44 adjacent its lower edges as can be seen in FIGS. 2 and 3. The curved plate 24 may be made of a resilient or elastic material such as plastic which can spread in outward radial direction during the time it is being forced over the lateral sewer pipe 12. After having been forced over the lateral sewer pipe 12, the resiliency of the curved plate 24 causes it to snap back into its original configuration so that it retentively engages the outer surface of the lateral sewer pipe 12.

FIG. 1 shows the three sweeps 25, 26, 27 of the access assembly 18 which create a bi-directional fitting apparatus. The central or first sweep 26 is substantially aligned with an aperture 31 in the curved plate 24. As explained below in more detail, the aperture 31 in the curved plate 24 is substantially aligned with an access opening 34 cut into the lateral pipe 12 to provide access from any of the sweeps 25, 26, 27 of the access assembly 18 to the inside of the lateral pipe 12. The upstream sweep (second) 25 includes an opening 33 to provide communication from the upstream sweep 25 to the central sweep 26. Similarly, the downstream (third) sweep 27 includes an opening 37 to provide communication from the downstream sweep 27 to the central sweep 26. The downstream sweep 27 and upstream sweep 25 include an angled wall portion 19, 29 extending downward and inward toward the aperture opening 31. The angle of the wall may be between 10 and 80 degrees from a longitudinal axis of the pipe 12 in order to direct pipe rehabilitation components downward and inward toward the aperture 31 in the central sweep 26. In one embodiment the angle is between about 30 and 50 degrees. In one embodiment the downstream sweep 27 and upstream sweep 25 have an upper wall portion 29A, 19A extending in a first direction, a lower wall portion 29B, 19B extending in a second direction, and an angled wall portion 19, 29 between the upper wall portion 29A, 19A and the lower wall portion 29B, 19B. The angled portion 19, 29 helps transition the wall from generally vertical (where the sweep 25, 27 is combined with its respective riser pipes 21, 23) to an angle less than 90 degrees from the top (horizontal) surface of the lateral pipe 12 (where the sweep 25, 27 opens into the central sweep 26). It should be noted that the angled portion 19, 29 may be a curved surface as shown in FIG. 1 or it may be a flat angled ramp extending at an angle as shown in FIG. 2. In embodiments where the angled portion 19, 29 is a curved surface, the angle changes through the radius of curvature as the angled portion 19, 29 extends downward and inward toward the central sweep 26. As one embodiment, the upper wall portion 29A, 19A is substantially perpendicular to the longitudinal axis of the lateral pipe 12 and the lower wall portion 28B, 19B exits into the central sweep 26 at an angle of about 30-50 degrees to the longitudinal axis of the lateral pipe 12 with a radius of curvature connecting the upper wall portion 29A, 19A and the lower wall portion 29B, 19B.

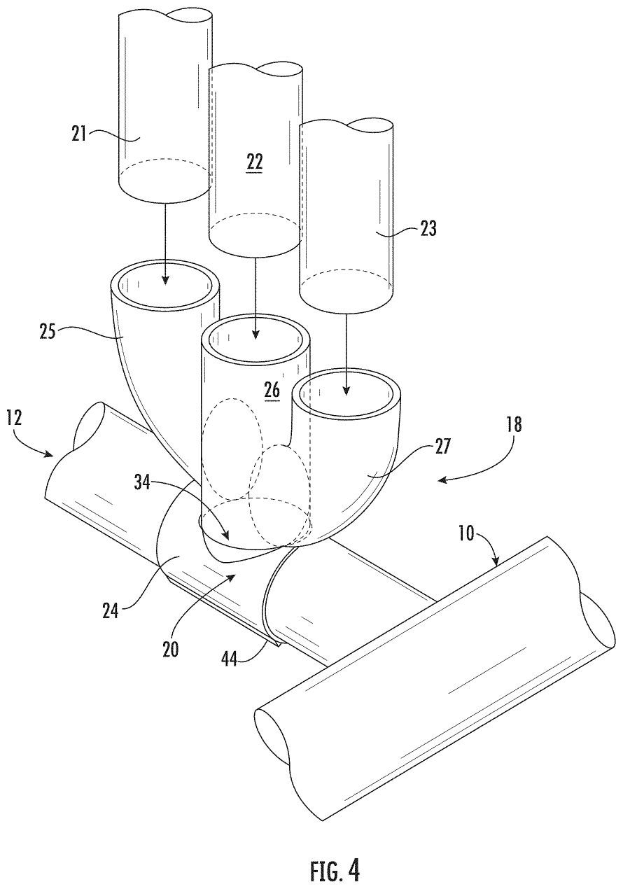

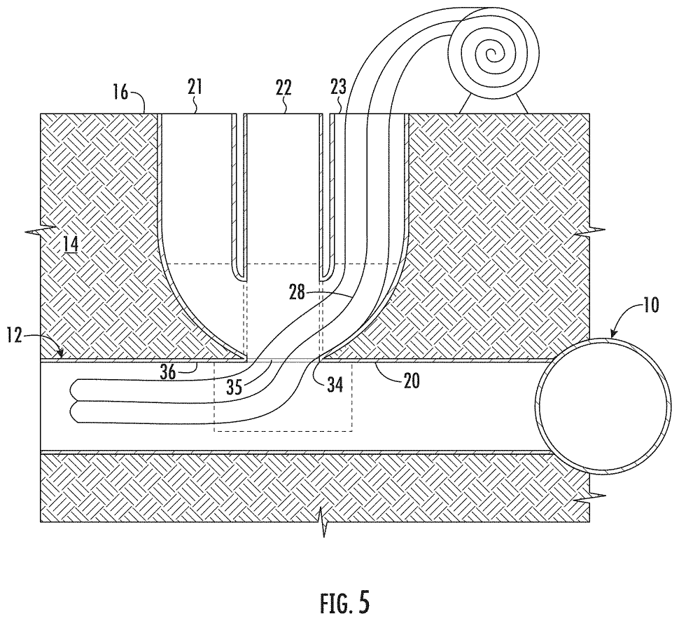

As shown in FIGS. 4 and 5, each sweep 25, 26, 27 is adapted to be combined with a riser pipe 21, 22, 23. Each riser pipe 21, 22, 23 includes a lower end 39 which is combined with the corresponding sweep 25, 26, 27, and an upper end which is adjacent the surface 16 of the ground 14. Extending downwardly through the riser pipe 21, 22, 23 is a riser pipe bore. As explained below in more detail, an access opening 34 is cut in the lateral sewer pipe 12 so as to provide communication from the riser pipe bore into the aperture opening 31 in the lower portion of the central sweep 26 and further into the interior of the lateral sewer pipe 12.

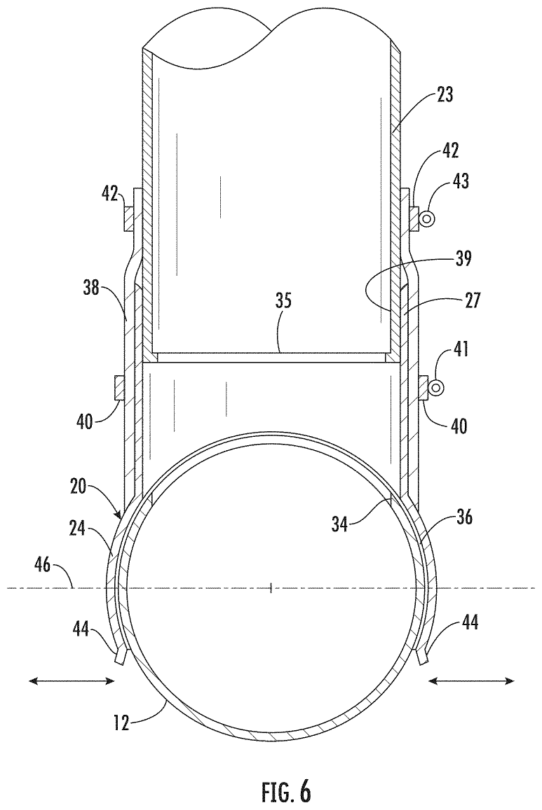

As shown in FIG. 6, the lower end 39 of riser pipe 21, 22, 23 rests on an annular rib 35 which extends around the inside of each sweep 25, 26, 27. Only sweep 27 is shown in FIG. 6, but the connection of each riser pipe 21, 22, 23 with its corresponding sweep 25, 26, 27 may be the same as described herein. The lower end 39 of the riser pipe 23 extends inside the sweep 27 and is secured there by a flexible sleeve 38 having clamps 40, 42 extending there around and having clamp screws 41, 43 which can be tightened to secure the attachment of riser pipe 23 to the saddle 20. While the flexible sleeve 38 and the clamps 40, 42 are shown, other methods of attachment may be used. For example, the pipe could be attached by an adhesive or other material conventionally used by plumbers in connecting plastic pipe together. In this embodiment the flexible sleeve 38 and clamps 40, 42 are not necessary to secure the components together.

FIG. 6 shows the manner in which the saddle 20 snaps over the lateral sewer pipe 12. The line 46 represents the diameter of the lateral sewer pipe 12. As can be seen, in one embodiment the lower ends and/or flanges 44 of the curved plates 24 extend beyond the diameter line 46 of lateral sewer pipe 12. When the saddle is pressed downwardly these flanges 44 spread in an outward radial direction and then snap back in place to secure the saddle 20 to the outer surface of the lateral sewer pipe 12. This can be accomplished remotely by merely pressing downwardly on the upper end of one or more of the riser pipe 21, 22, 23 so as to snap the saddle 20 in place. In other embodiments the lower ends of the curved plates 24 need not extend beyond the diameter of the lateral sewer pipe 12 (line 46). A sealing material 36 may be used to help combine the components and provide a fluid tight seal between the concave lower surface of the curved plate 24 and the convex or curved outer surface of the sewer pipe 12. The sealing material 36 may be an adhesive, cured resin or other cured hardenable material. It also can be a physical seal such as a gasket or two-sided tape or other material.

In order to install the access assembly 18 the first step is to locate the lateral sewer pipe 12 from above ground. This can be accomplished by various means, among which include the conventional use of a camera that is movable within the main sewer line 10 or the lateral sewer pipe 12 and by sensing the location of the camera from above ground by ultrasonic or other means. Once the lateral sewer pipe is located, an excavation hole is provided. This may be accomplished by numerous boring means such as the use of augers or other materials. However, the preferred method is to use a vacuum excavator manufactured by Vactor Manufacturing under the trade name VACTOR®, at the address of 1621 South Illinois Street, Streator, Ill. 61364. This device excavates a hole and removes the soil from the hole with a minimum of disturbance of the soil. The diameter of excavation hole need be only large enough to permit the insertion of the saddle 20 into the hole, and need be only deep enough to expose a portion of the outer surface of the lateral sewer pipe 12.

When the excavation of the hole is completed, the access assembly 18 is inserted into the hole and pressure is applied on the upper end of one or more of the riser pipes 21, 22, 23 to force the curved plate 24 thereon and the lower edges to spread radially outwardly and then snap back into place to secure the saddle 20 to the outer surface of the sewer pipe 12. This all can be done above ground remotely from the location of the lateral sewer pipe 12 and does not require the installer to enter the excavation hole.

Before snapping the saddle 20 in place, a sealing material 36 may be placed on the under surface of the saddle 20. The sealing material may be an adhesive, an uncured plastic resin or it can be physical sealing means such as gaskets or double-sided tape. Once the saddle 20 is snapped in place, the sealing material 36 is allowed to cure and helps provide a fluid tight seal between the saddle 20 and the sewer pipe 12.

Next a cutting tool is inserted through the riser pipe 22 bore into engagement with the outer surface of the lateral sewer pipe 12. An access opening 34 is cut in the outer surface of the lateral sewer pipe 12 thereby providing communication from above ground into the interior of the lateral sewer pipe 12. The preferred machine for making the access opening 34 is a cutting machine manufactured by Milwaukee Tools under the trade name Diamond coring bits, sold in Grainger Catalog at address of 2701 Ogden Avenue, Downers Grove, Ill. 60515.

After the access assembly 18 has been secured in place and the access opening 34 cut, a cap (not shown) is placed over the upper end of the riser pipes 21, 22, 23 and the excavation hole is filled in. This provides an access to the interior of the lateral sewer pipe at any time in the future when it is needed merely by removing the cap and using the riser pipe bore to gain access to the interior of the lateral sewer pipe 12.

The use of the present invention does not require the operator to make an excavation hole large enough for the operator to enter the hole and work adjacent the buried lateral sewer pipe. Instead the installer works from above ground, and merely inserts the access assembly 18 from a remote position above ground. This minimizes the disturbance of the soil around the access assembly 18 and is quicker and more easily done than prior methods.

After the access assembly 18 is combined with the lateral pipe 12, a liner, camera, or other pipe rehabilitation component 28 may be inserted through the assembly and into the lateral pipe 12. The rehabilitation component 28 may be inserted into one of the outer riser pipes 21 or 23 to direct the component 28 either upstream or downstream in the lateral pipe 12. As shown in FIG. 5, if it is desired to insert a component 28 into the lateral pipe 12 in an upstream direction, the component 28 is inserted into the downstream sweep 27 through access pipe 23. The change in direction of the wall at the angled portion 29 directs the component 28 upstream as the component 28 passes through opening 37, into the central sweep 26, then through access opening 34 into the lateral pipe 12. In other words, the downward and inward angle of the sweep 27 directs the component 28 in the correct direction even before the component 28 enters the lateral pipe 12. Similarly, if it is desired to insert a component 28 into the lateral pipe 12 in a downstream direction, the component 28 is inserted into the upstream sweep 25 through access pipe 21. The downward and inward direction of the sweep 25 at angled portion 19 directs the component 28 downstream as the component 28 passes through opening 33, into the central sweep 26, then through access opening 34 into the lateral pipe 12.

In the drawings and specification there has been set forth a preferred embodiment of the invention, and although specific terms are employed, these are used in a generic and descriptive sense only and not for purposes of limitation. Changes in the form and the proportion of parts as well as in the substitution of equivalents are contemplated as circumstances may suggest or render expedient without departing from the spirit or scope of the invention ask further defined in the following claims.

1. An apparatus for providing access to an interior bore of a pipe located below a surface of the ground and having an outer curved surface, the apparatus comprising:
a curved plate having a longitudinal axis and adapted to engage the outer curved surface of the pipe, said curved plate having an aperture therein; and
a first sweep combined with the curved plate and substantially aligned with the aperture in the curved plate;
a second sweep having a wall with an upper wall portion adapted for connection to a riser pipe and a lower wall portion in communication with the first sweep through an opening;
wherein the upper wall portion of the second sweep extends in a direction substantially perpendicular to the longitudinal axis of the curved plate and the lower wall portion extends toward the opening at an angle less than ninety degrees from the longitudinal axis of the curved plate.

2. The apparatus of claim 1 further comprising:
a third sweep in communication with the first sweep through an opening, said third sweep having a wall with an upper wall portion;
wherein the wall in the third sweep extends at an angle from the upper wall portion toward the opening.

3. The apparatus of claim 2 wherein the first sweep is combined with the curved plate between the second sweep and the third sweep.

4. The apparatus of claim 2 further comprising a first riser pipe combined with the first sweep, a second riser pipe combined with the second sweep, and a third riser pipe combined with the third sweep.

5. The apparatus of claim 1 wherein the curved plate has a radius of curvature and the pipe has a radius of curvature, and the radius of curvature of the curved plate is less than the radius of curvature of the pipe to bias the plate against the pipe.

6. The apparatus of claim 1 wherein the wall from the upper wall portion to the opening includes a curve.

7. The apparatus of claim 1 wherein the wall from the upper wall portion to the opening includes a straight portion.

8. The apparatus of claim 1 wherein the angle the lower wall portion extends toward the opening is between about 30 and 50 degrees from the longitudinal axis of the curved plate.

9. An apparatus for providing access to an interior bore of a pipe located below a surface of the ground and having an outer curved surface, the apparatus comprising:
a curved plate adapted to engage the outer curved surface of the pipe, said curved plate having an aperture therein;
a first sweep combined with the curved plate and substantially aligned with the aperture in the curved plate;
a second sweep having a wall with an upper wall portion extending in a first direction and a lower wall portion extending in a second direction, wherein the first direction is different than the second direction; and
wherein the lower wall portion of the second sweep is in communication with the first sweep through an opening.

10. The apparatus of claim 9 further comprising an angled wall portion between the upper wall portion and the lower wall portion, wherein the angled wall portion extends at a downward angle toward the opening.

11. The apparatus of claim 10 wherein the wall at the angled wall portion is curved.

12. The apparatus of claim 10 wherein the wall at the angled wall portion is straight.

13. The apparatus of claim 9 further comprising:
a third sweep having a wall with an upper wall portion extending in the first direction, a lower wall portion extending in a different-direction; and
an opening between the first sweep and the third sweep.

14. The apparatus of claim 13 wherein the first sweep is combined with the curved plate between the second sweep and the third sweep.

15. The apparatus of claim 13 further comprising a first riser pipe combined with the first sweep, a second riser pipe combined with the second sweep, and a third riser pipe combined with the third sweep.

16. The apparatus of claim 9 wherein the first direction is generally perpendicular to the second direction.

17. The apparatus of claim 9 wherein the curved plate has a radius of curvature and the pipe has a radius of curvature, and the radius of curvature of the plate is less than the radius of curvature of the pipe to bias the plate against the pipe.

18. The apparatus of claim 9 further comprising an adhesive material disposed between the curved plate and the outer curved surface of the pipe.

19. The apparatus of claim 9 wherein the lower wall portion extends toward the opening an angle of about 30-50 degrees from a longitudinal axis of the curved plate.

20. A method of providing access to an interior bore of a pipe buried beneath a surface of the ground, the pipe having an outer curved surface and extending in a first direction, the method comprising:
excavating the ground to expose a portion of the pipe;
taking an access assembly comprising a curved plate having a concave surface adapted to engage the outer curved surface of the pipe, a first sweep substantially aligned with an aperture in the curved plate, second direction, a second sweep in communication with the first sweep through an opening, said second sweep having a wall with an upper portion extending in a first direction and a lower wall portion extending in a second direction that is different from the first direction, an a first riser pipe combined with the first sweep, and a second riser pipe combined with the second sweep;
attaching the access assembly to the pipe; and
making an access hole in the pipe aligned with the aperture of the curved plate.

21. The method of claim 20 further comprising:
applying an uncured and hardenable sealing material to the concave surface of the curved plate before attaching the pipe access assembly to the pipe; and
allowing the sealing material to cure and harden after attaching the access assembly to the pipe.

22. The method of claim 20 wherein the curved plate of the assembly covers more than 180° of the pipe after the assembly has been attached to the pipe.

23. A method of providing access to an interior bore of a pipe buried beneath a surface of the ground, the pipe having an outer curved surface and extending in a first direction, the method comprising:
excavating the ground to expose a portion of the pipe;
taking an access assembly comprising a curved plate having a concave surface adapted to engage the outer curved surface of the pipe, a first sweep substantially aligned with an aperture in the curved plate, a second sweep in communication with the first sweep through an opening, said second sweep having a wall with an upper wall portion extending in a first direction and a lower wall portion extending in a second direction that is different than the first direction, a first riser pipe combined with the first sweep, and a second riser pipe combined with the second sweep;
attaching the access assembly to the pipe;
making an access hole in the pipe aligned with the aperture of the curved plate; and
inserting a pipe rehabilitation component through the second riser pipe and into the second sweep where the lower wall portion directs the component toward the aperture then into the interior bore of the pipe.

24. The method of claim 23 wherein the access assembly further comprises a third sweep having a wall with an angled portion extending toward the aperture and a third riser pipe combined with the third sweep.

25. The method of claim 23 wherein the second direction is upstream within the pipe.

26. The method of claim 23 further comprising:
applying an uncured and hardenable sealing material to the concave surface of the curved plate before attaching the pipe access assembly to the pipe; and
allowing the sealing material to cure and harden after attaching the access assembly to the pipe.

27. The method of claim 23 wherein the curved plate of the assembly covers more than 180° of the pipe after the assembly has been attached to the pipe.
